(19) United States
(12) Patent Application Publication
(10) Pub. No.: US 2014/0254305 A1
(43) Pub. Date: Sep. 11, 2014

(54) AUTO-CONTROLLED AIR-OXYGEN BLENDER

(71) Applicants: Richard Brand Caso, Mission Viejo, CA (US); Irving Quam, Eastvale, CA (US)

(72) Inventors: Richard Brand Caso, Mission Viejo, CA (US); Irving Quam, Eastvale, CA (US)

(21) Appl. No.: 13/787,007

(22) Filed: Mar. 6, 2013

(51) Int. Cl. B01F 15/00

(52) U.S. Cl. CPC B01F 15/00266
USPC 366/152.1

(57) ABSTRACT

A gas mixing apparatus comprising an oxygen input-source, the oxygen input-source further comprising an oxygen sensor, a gas input-source, the gas input further comprises a first gas flow sensor and a combined gas output-source. The gas output source further comprises a second gas flow sensor. The gas mixing apparatus further comprise an electronic mixing-valve, the electronic mixing valve adapted to be controlled by an input-knob or by a CPU. Wherein, the electronic mixing valve, responds to a CPU, the CPU adapted to receive signals from an accelerometer, an oxygen sensor, a gas flow sensor, an input-knob, a digital input source, and a wireless transceiver; wherein said CPU controls said electronic mixing valve by comparing stored preset values and adjusting said electronic mixing valve through a feedback loop. The method of precisely mixing gas and oxygen comprising the steps of using an electronic mixing valve; said electronic mixing valve adapted to receive processed signals from a CPU. Wherein said CPU creates a feedback loop by receiving signals from an accelerometer, an oxygen sensor, a gas flow sensor, a pulse oximeter, an input-knob, a digital input source, and a wireless transceiver.

### FIELD OF THE INVENTION

The present invention relates to the art of oxygen and, or gas mixer control devices.

### STATEMENT REGARDING FEDERALLY-SPONSORED RESEARCH AND DEVELOPMENT

Not applicable.

### BACKGROUND OF THE INVENTION

Several forms of oxygen therapy have been in use since the late nineteenth century. The earliest recorded use of oxygen to treat a patient was by Dr. Fontaine in 1879. In the 1950s, hyperbaric (higher than normal air pressure) oxygen treatment was used by cancer researchers. Recently, oxygen therapy has also been promoted as a purification treatment for mass-market consumers. Oxygen “bars” can be found in airports and large cities, and provide pure oxygen in minute sessions for a few dollars.

While proponents claim that breathing oxygen will purify the body, most medical doctors do not agree. There is a problem with current oxygen blenders that oxygen can be harmful to people with lung diseases if it is not dosed with accuracy, and current blenders do not do so.

An Oxygen Blender is a medical device used to mix Medical Air and hospital grade Oxygen (O2) into a gas source ranging from 21% (normal) to 100% (max) oxygen.

In general, the typical clinical situations in which the administration of supplemental oxygen is indicated are: (1) Profound but potentially reversible hypoxia that appears amenable to the short-term administration of high concentrations of oxygen. Examples would include the patient who is apneic, is suffering from cardiovascular collapse, or is a victim of carbon monoxide poisoning. (2) Conditions in which there is a need to reduce the work load of the cardiovascular and pulmonary systems and at the same time assure an adequate supply of oxygen to the tissues. Congestive heart failure, myocardial infarction, and such acute pulmonary diseases as pulmonary embolism and pneumonia are examples of the types of clinical situations that are best treated by the administration of moderate levels of oxygen concentration. (3) Evidence of hypoventilation, whether from anesthesia and sedation, chronic obstructive pulmonary disease, or other conditions.

One example of the problems with current oxygen mixers is that if a patient who is hypoventilating is in danger of suffering from an adverse effect of oxygen therapy because increased oxygenation can lead to decreased respiratory effort. In other words, the oxygen acts as a respiratory depressant and may produce an increase in partial pressure of carbon dioxide in the arterial blood, thus contributing to rather than overcoming the problem of hypoxia. If there is evidence that the patient is hypoventilating, it may be necessary to administer the oxygen by assisted or controlled dosage.

The delivery of appropriate and effective oxygen therapy requires frequent monitoring of arterial blood gases, oxygen saturation and correction of the oxygen dosage. Oxygen saturation can be assessed by SaO2 or SpO2. SaO2 is oxygen saturation of arterial blood, while SpO2 is oxygen saturation as detected by a pulse oximeter. An initial blood SpO2 gas analysis at the time the therapy is started provides baseline data with which to evaluate changes in the patient's status and provides for later adjustments.

In addition to monitoring blood gases to assess the patient's need for and response to supplemental oxygen, it is important to provide accurate dose to prevent hypoxemia.

This monitoring and adjusting the Oxygen dose by hand is cumbersome, antiquated and inaccurate. The dosage and method of administration is crucial since oxygen is considered a drug and should be prescribed and administered as such. Inaccurate manual dosage is never acceptable.

Another problem with current manual oxygen blenders is that the clinical signs and symptoms of hypoxemia may vary from patient to patient, and they should not be depended upon manually adjusting for oxygen insufficiency. This is especially true of cyanosis, a symptom that depends on local circulation to the area, the red cell count, and hemoglobin level.

Currently, since oxygen blenders have “fixed sets” of dosage, the dosage and mode of administration is limited to the following categories:

(1) High concentrations above 50% usually are prescribed when there is a need for the delivery of high levels of oxygen for a short period of time to overcome acute hypoxemia, as in cardiovascular failure and pulmonary edema. The flow rate may be as high as 12 liters per minute, administered through a close-fitting face mask with or without a rebreathing bag, or via an endotracheal tube.
(2) Moderate concentrations of oxygen are indicated when the patient is suffering from impaired circulation of oxygen, as in congestive heart failure and pulmonary embolism, or from increased need for oxygen, as in thyrotoxicosis, in which the increased metabolic rate creates a need for more oxygen. The rate of flow should be 4 to 8 liters per minute, administered through an air entrainment mask that delivers concentrations above 23 per cent, or in a dosage of 3 to 5 liters per minute through a nasal cannula.
(3) Low concentrations of oxygen are indicated when the patient is receiving oxygen therapy over an extended period of time, as in chronic obstructive pulmonary disease, and there is the possibility of hypoventilation and the danger of increased CO2 retention. The rate of flow should be 1 to 2 liters per minute, administered through a nasal cannula, or via an air entrainment mask that delivers 24 to 35 per cent oxygen.

The issue with these “fixed sets” of dosage is that there are people that do not fall within the sets depending of the pulmonary disease. Therefore the patient is always being adjusted to the machine's capability. The blenders are designed to produce a predictable percentage of oxygen when the inlet pressures are equal, based on the position of the control knob, hence blender-centric.

There is a need in the industry to for an oxygen blender to be designed as an automation of oxygen delivery, based on patient need, hence patient-centric.

What is needed is an intelligent oxygen blender, or auto-controlled oxygen blender, that does not produce a percentage of oxygen based on the position of the control knob. Instead, it would either increase or decrease the amount of oxygen being delivered to the patient according to the patient's need.

There is a need to make a device where it does no longer need to balance the gases by hand thus an automated oxygen blender, allowing for the automation of oxygen delivery based on patient need.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1A depicts at least one embodiment of the invention namely, an orthogonal 3D view of the auto-controlled air-oxygen blender.

FIG. 1B depicts at least one embodiment of the invention namely, an orthogonal 3D view of the auto-controlled air-oxygen blender.

FIG. 1C depicts at least one embodiment of the invention namely, an orthogonal 3D view of outside of the auto-controlled air-oxygen blender.

FIG. 2 depicts at least one embodiment of the invention namely, a side view of the auto-controlled air-oxygen blender.

FIG. 3 depicts at least one embodiment of the invention namely, a front view of the auto-controlled air-oxygen blender.

FIG. 4 depicts at least one embodiment of the invention namely, a bottom view of the auto-controlled air-oxygen blender.

FIG. 5 depicts at least one embodiment of the invention namely, a cross-sectional view of the auto-controlled air-oxygen blender.

FIG. 6 depicts at least one embodiment of the invention namely, how the air-oxygen blender works in flowchart form.

FIG. 7 depicts at least one embodiment of the invention namely, how the air-oxygen blender works without balancing modules in flowchart form.

FIG. 8 depicts at least one embodiment of the invention namely, a flowchart depicting the initial set up for oxygen therapy of the auto-controlled air-oxygen blender.

FIG. 9 depicts at least one embodiment of the invention namely, a flowchart depicting the set up for achieving and maintaining desired SpO2 of the auto-controlled air-oxygen blender.

FIG. 10 depicts at least one embodiment of the invention namely, a flowchart depicting the differential pressure alarm of the auto-controlled air-oxygen blender.

FIG. 11 depicts at least one embodiment of the invention namely, a flowchart depicting the impact alarm of the auto-controlled air-oxygen blender.

### DESCRIPTION OF THE INVENTION

The present invention depicts an inventive solution to the fore mentioned issues related to oxygen, air and gas blender or mixers.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, “oxygen blender” refers to an apparatus that is used to mix: air and oxygen, or a mixture of a multitude of gases. Thus, as a non-limiting example, gases comprise, oxygen, ozone, hydrogen peroxide, or water vapor. Said apparatus available in single port or multi-ports.

As used herein in the specification and in the claims, “gas” means any compressible fluid such as oxygen, nitrogen, hydrogen, air (a mixture of dry air contains roughly (by volume) 78.09% nitrogen, 20.95% oxygen, 0.93% argon, 0.039% carbon dioxide, and small amounts of other gases or any combination thereof. “Gas” also contains a variable amount of water vapor, on average around 1%), carbon dioxide, nitrous oxide, anesthetic and other similar gases or any combination thereof.

As used herein in the specification and in the claims, the term “controls” refers to; direct, instruct, call on, require, manipulate, gives instructions in form of code or (digital or analog) signals, and control of an element over another.

As used herein in the specification and in the claims, the term “link” or “linked” refers to a connection, connector, coupling, joint or a relationship between two things or elements where one thing affects the other, both wireless, wired or in combination of both.

As used herein in the specification and in the claims, the term “responds” refers to an answer, reply, rejoin, retort, riposte, counter reaction, react, reciprocate, retaliate in form of code or (digital or analog) signals or any combination thereof.

As used herein in the specification and in the claims, the term “transmit” or “transmits” refers to pass on at least one signal or information, in both digital or analog form, from one place or element to another both wireless, and wired or in combination of both.

“Demountably-attached” as used herein in the specification and in the claims, means the element can be connected or physically removed by either cables or wirelessly, by using wireless signals or in combination of both.

### ABBREVIATIONS

### FIO2—Fractional Concentration of Inspired Oxygen

SpO2—Oxygen saturation as detected by the pulse oximeter
PaO2—Partial pressure of arterial blood

### DISS—Diameter Indexed Safety System

### NIST—Non-Interchangeable Screw Thread

lpm—Liters Per Minute
psi—Pounds Per Square Inch
kpm—Kilopond meter

The invention herein represents a great leap from today's blended oxygen delivery. Current designs are “blender-centric,” in that they are designed to produce a predictable percentage of oxygen when the inlet pressures are equal, based on the position of a control knob.

The invention herein, is patient-centric. In at least one embodiment of the invention, the blender produces a percentage of oxygen/gas mixture by either increasing or decreasing the amount of oxygen being delivered to the patient automatically controlled according to the patient's need (as detected by at least one sensor) and not based on the position of the control knob.

At least one of the advantages, is that it does no longer need to balance the gases, and the mixing valve will be much simpler.

In this non limiting example, normal oxygen saturation at sea level is 94%-98%. If the device herein is programmed for a 96% saturation, the blender will deliver higher concentrations of oxygen to the patient, decreasing the amount of oxygen delivered as the patient nears and stabilizes at 96% based on the SPO2 feedback loop. Should the patient's saturation decrease, additional oxygen will be given. As the saturation stabilizes and/or begins to increase, the blender will decrease the amount of oxygen being delivered. This will automate the entire process of starting a patient on oxygen and weaning the patient off of oxygen.

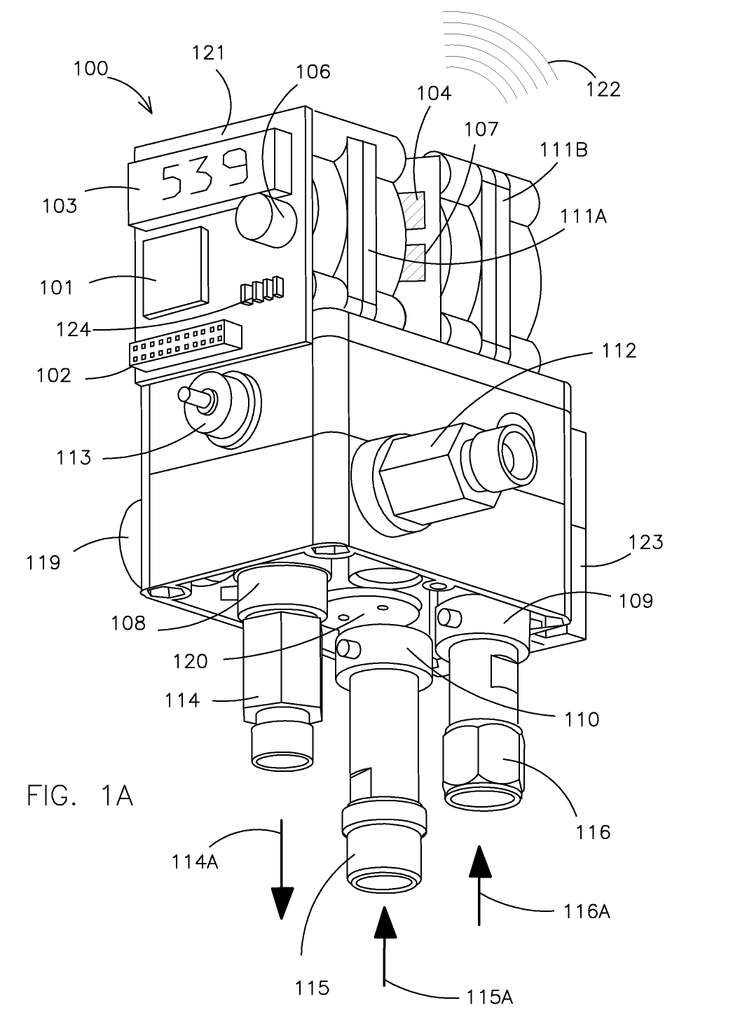

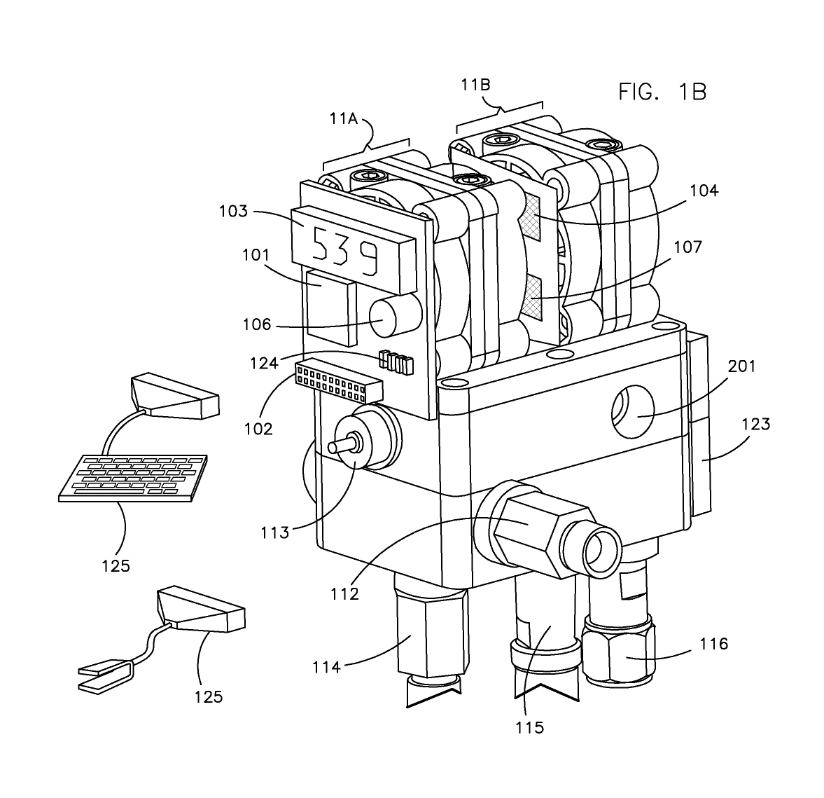

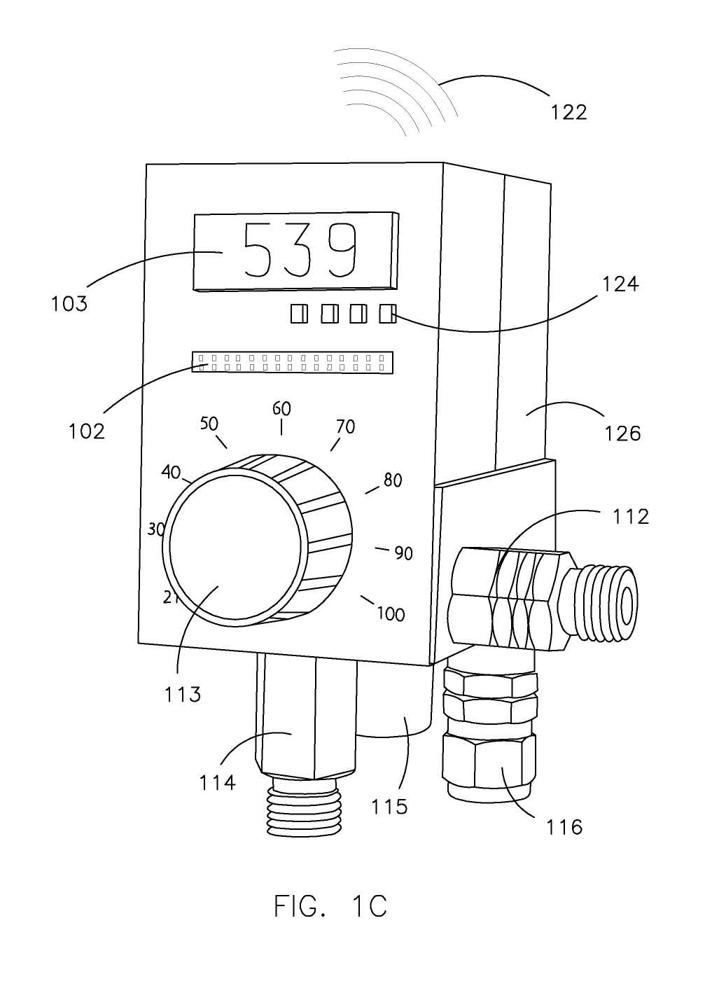

Referring now to the drawings in detail, in at least one embodiment of the invention, as seen in FIGS. 1A, 1B, and 1C, the gas mixing apparatus comprises; at least one oxygen input-source 116, further comprising at least one oxygen sensor 109, at least one gas input-source 115, further comprising a first gas flow sensor 110, at least one combined (gas or gas/oxygen mixture) output-source 114, further comprising a second gas flow sensor 108, at least one optional output port 119, an auxiliary low flow outlet port with bleed 112, a wireless transceiver 107, adapted to send and receive wireless signals 122 to a network, at least one motherboard 121, further comprising a first CPU 101 and a second CPU 104, at least one accelerometer 106, at least one i/o connector 102 adapted to be demountably-attached to at least one digital input source 125, at least one digital display 103, at least one mixing valve 113, at least one pressure balancing assembly 111A-B, at least one alarm comprising a reed plate 120 and a sleeve 201. The invention herein, further comprise at least one DC battery pack 123 or wall AC input converter or any combination thereof.

Oxygen flow 116A is shown, gas flow 115A is depicted also, and combined gas/oxygen mixture 114A exiting the combined gas output-source.

In at least one embodiment, the at least one digital display is an LCD display 103, a plurality of LEDs 124 and any combination thereof, and the said digital input 125 source comprises, a keyboard, an optical scanner, a camera, pulse oximeter 125A, and a mouse, or any combination thereof. The device is covered with a protective casing as seen in FIG. 1C, number 126.

The pulse oximeter 125A in FIG. 1B measures the absorption of red and infrared light by pulsatile blood. Oxygenated blood absorbs light at 660 nm (red light), whereas deoxygenated blood absorbs light preferentially at 940 nm (infra-red). Pulse oximeters consist of two light emitting diodes, at 660 nm and 940 nm, and two light collecting sensors, which measure the amount of red and infra-red light emerging from tissues traversed by the light rays. The relative absorption of light by oxyhemoglobin (HbO) and deoxyhemoglobin is processed by the device and an oxygen saturation level is reported. The device directs its attention at pulsatile arterial blood and ignores local noise from the tissues. The result is a continuous qualitative measurement of the patients oxyhemoglobin status. Oximeters deliver data about pulse rate, oxygen saturation (SpO2) and even cardiac output.

In another embodiment, the said at least one CPU 101 controls said at least one electronic mixing-valve by the input of at least one oxygen sensor 109, a first gas flow sensor 110, a second gas flow sensor 108, at least one mixing valve 113, said wireless transceiver 107, and said digital input source or any combination thereof. A second CPU 104, controls and processes the signals from the wireless transceiver 107 and other antennas such as bluetooth or IEEE 802.11, any other short range antenna that functions in similar way would serve the same purpose to accomplish the same result.

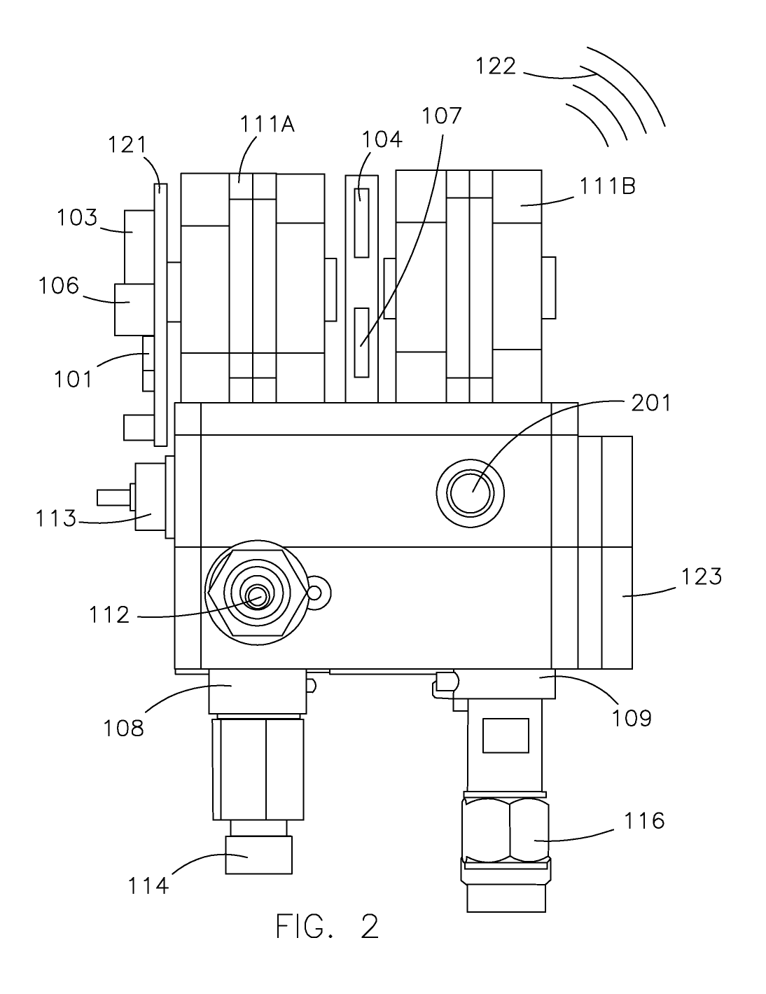

In FIG. 2, a side view of the invention herein, it comprises at least one oxygen input-source 116, further comprising at least one oxygen sensor 109, at least one combined gas output-source 114, further comprising a second gas flow sensor 108, a wireless transceiver 107, adapted to send and receive wireless signals to a network, at least one motherboard 121, further comprising a first CPU 101, a send CPU 104, at least one accelerometer 106, at least one i/o connector 102 adapted to be demountably-attached to at least one digital input source, at least one digital display 103, at least one pressure balancing assembly 111A, 111B, at least one alarm comprising a sleeve 201. The invention herein, further comprise at least one DC battery pack 123 or wall AC input converter or any combination thereof.

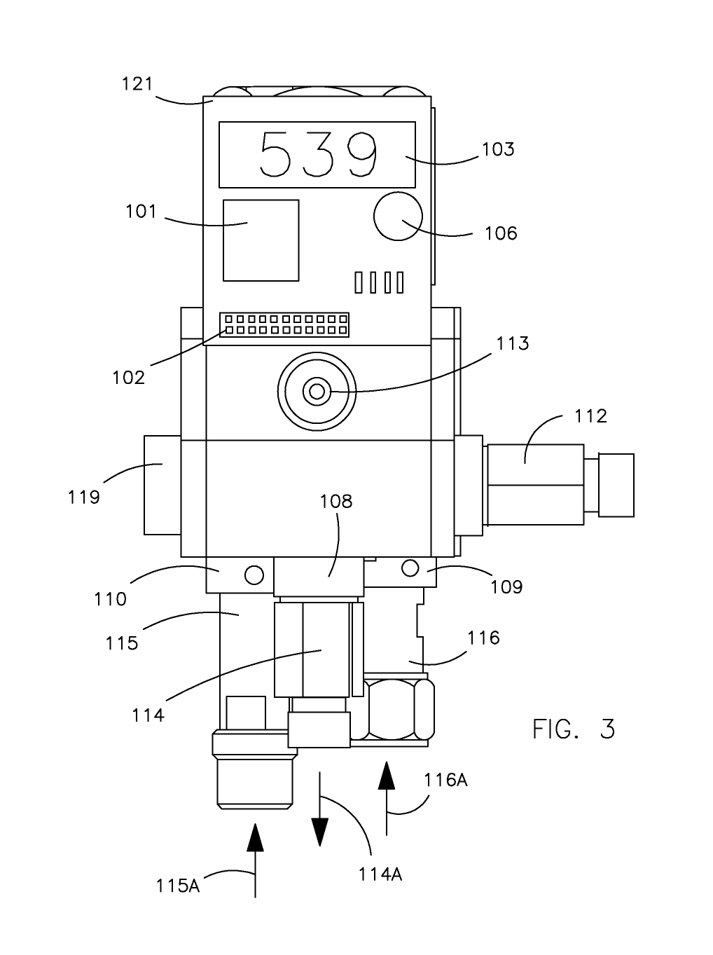

In FIG. 3, a front view of the invention herein, the direction of the oxygen flow 116A is shown as it enters the oxygen input-source 116, through oxygen sensor 109. The gas flow 115A is depicted as it enters the gas input-source 115, though gas flow sensor 110. FIG. 3 further depicts the combined gas/oxygen mixture 114A exiting the combined gas output-source 114 though gas flow sensor 108.

Other elements of depicted in FIG. 3 are at least one motherboard 121, further comprising at least one CPU 101, at least one accelerometer 106, at least one i/o connector 102 adapted to be demountably-attached to at least one digital input source, at least one digital display 103, at least one mixing valve 113, at least one optional output port 119, and at least one low flow auxiliary outlet port with bleed 112.

As a non limiting example, as used in the invention herein, flow sensors 108, 120, 109 are MEMS Flow Chip from OMRON INC, comprise a highly sensitive MEMS flow chip that is only 1.5 mm2×0.4 mm thick. The MEMS flow chip has two thermopiles on either side of a tiny heater element used to measure the deviations in heat symmetry caused by gas flowing in either direction. A thin layer of insulating film protects the sensor chip from exposure to the gas. When even the smallest flow is present, temperature on the side of the heater facing the flow cools, and warms up on the other side of the heater—heat symmetry collapses. The difference of temperature appears as a differential voltage between the two thermopiles, proportional to the mass flow rate. Any other non-MEMS flow sensor can be used in the same manner, for the same purpose to achieve the measuring of the flow of gas or oxygen.

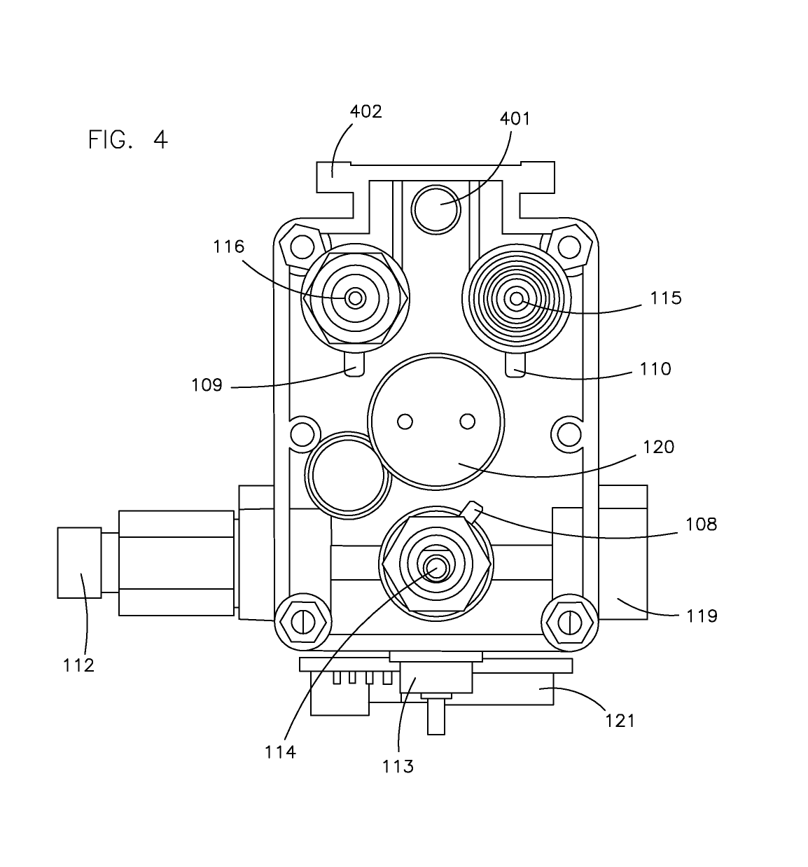

FIG. 4, the bottom view of the invention herein, depicts at least one oxygen input-source 116, further comprising at least one oxygen sensor 109, at least one combined gas output-source 114, further comprising a second gas flow sensor 108, at least one motherboard 121, at least one alarm comprising a reed plate 120. The invention herein, further comprise at a raceway 401 and a dovetail mount 402.

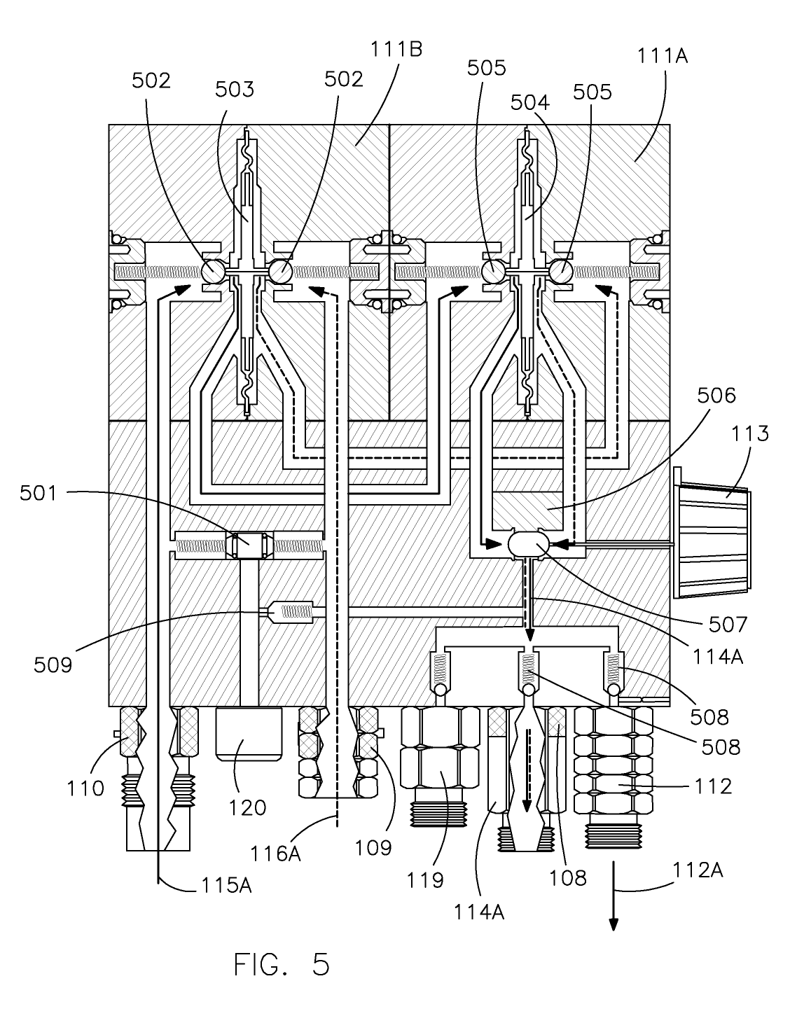

FIG. 5, comprises at least one embodiment of the invention, namely a cross-section of the working of this ingenious air mixer. Here at least one electronic mixing-valve 507, said electronic mixing valve adapted to be controlled by at least one mixing valve 113 and/or by at least one CPU 101 using a feedback loop. The gas mixing apparatus herein further comprises one electronic mixing valve 507 which controls oxygen concentrations using at least one feedback loop from data gathered from oxygen sensor 109, a first gas flow sensor 110, at least one combined gas output-source 114, a second gas flow sensor 108, a wireless transceiver 107, and at least one digital input source 125.

In the invention herein, the increasing or decreasing amount of oxygen and gas delivered to the patient in flow 112A is automatically controlled according to the patient's need through at least one sensor. The increasing or decreasing amount of mixed gas and oxygen to the patient is automated and controlled by CPU 101. The CPU contains pre-set values in the EEPROM memory that it compares against the values from the sensors. If the values are within the set limits, then it opens/closes the electronic valve 507 accordingly. This feedback loop is done almost in realtime.

The oxygen blender as shown in FIG. 5. precisely controls oxygen concentrations delivered to the outlet port 112. It requires reliable sources of air 115A and oxygen 116A to function properly. Control of source-gas pressure is important as the blender delivers gas mixtures at about 2 psi below the lowest source-gas pressure. Minor differences in incoming pressures are automatically compensated for within the blender by the use of the pressure balance assemblies 111A, 111B.

In one embodiment, both air 115A and oxygen 116A pressures are precisely balanced by dual pressure regulators 503, 504 and controlled by a calibrated electronic valve 507. Use of the control knob 113 can also be used in the alternative to set the exact oxygen and air mixtures for required concentrations of oxygen. If one of the gas supplies fail 115A, 116A, the blender allows the other gas to continue to flow to the patient and sounds an alarm 120 to warn of the failure. The alarm system consists of two diaphragm operated poppet valves 501, one of which opens and allows gas pressure to overcome spring tension on the valve and direct one of the gases to the audible alarm 120. Both air and oxygen pressures are equalized in the blender automatically by the pressure balance assemblies 111A, 111B.

At least one of the advantages of this invention is the unique modular design which cuts routine maintenance time in half as well as reduce maintenance costs. A signal 122 is sent via the wireless transceiver 107 to the maintenance department once the device is out of calibration, is damaged or needs replacement. The device consists of easy to replace modular components and is easily maintained. The large selection control knob 113 makes oxygen percentage adjustments by hand also possible. The infection control friendly housing 126 is smooth and easy to clean.

By combining a CPU 101 and manual input 113, this inventive device becomes highly accurate unit maintaining Fi02% even at very low flows. The tough plastic or metallic housing 126 and recessed mixing valve selection control knob 113 prevent accidental damage. Easily mounted with a universal mounting bracket 402, it can be advantageously detached from the mounting bracket without removing hoses.

In one embodiment of the invention and as a non-limiting example the following are typical specification of the mixer herein; Gas Supply Pressure 115A 30-75 PSIG, Knob 113 Adjustment Range 21%-100%, Primary Outlet Flow 112A Rangel5 to 120 lpm, Max Flow at 60% Knob Setting 120 lpm, Flow at 21%. Knob 113 Setting 90 lpm, Auxiliary Outlet Flow 112A Range 2 to 100 lpm, Accuracy±3% of full scale over the stated flow ranges. The Alarm/Bypass 120 Activation will begin when the inlet gas 115 pressures differ by 20 PSI±2 or more. The alarm 201 sound generator vibrating reed will stop when inlet pressure differential is 6 PSIG or less. Pressure drop is less than 6 PSIG at 50 PSIG inlet pressure and 40 lpm.

As depicted in FIG. 5, in one embodiment of the invention, the normal device operation begin as the medical air 115A and oxygen 116A enter the assembly through the inlet ports 115, 116 respectively. The inlets include duckbill check valves 502 (or 505 in the second plenum) to prevent back flow should one inlet pressure exceed the other, and a filter to prevent debris from entering the unit. The incoming gases apply (nearly) equal pressure against both sides of the alarm shuttle 501. This keeps the shuttle centered over the port to the bypass and alarm reed 120. The lack of air pressure in the bypass and alarm reed flow channel 509 allows the spring and outlet pressure to keep the check ball in place to seal the bypass.

As the gases 115A, 116A enter the first pressure balancing area 503, they flow past the check balls 502 and into the diaphragm chamber 111B. Pins on the diaphragms work to push the check balls 502 back should one pressure exceed the other. If the oxygen 115A side is of higher pressure than the medical air 116A, then the diaphragm 503 will be pushed toward the medical air 116A side. The pin on the diaphragm will push the air check ball back, allowing more air to flow into the air side of the chamber. At the same time, the pin on the oxygen 115A side will move away from the check ball, allowing the spring to push the check ball toward the seat, thus decreasing the flow of oxygen.

The increased air flow into the confined space on the air side of the diaphragm will increase the pressure, pushing the diaphragm back towards the oxygen side. As the diaphragm moves back, the check ball will move and decrease the flow of medical air, while the pin on the other side of the diaphragm will push the oxygen check ball back, increasing oxygen flow. This process of moving the diaphragm back and forth to balance the two pressures continues as long as there exists any inlet pressure differential.

When the gases leave the first balancing module 503, they enter the second 504. Here, the gases are continuously much closer in pressure, due to the action of the first balancing module 503. The actions of the first balancing module are repeated here to further equalize the pressures of the gases as they enter the electronic mixing valve 507. The electronic mixing valve 507 consists of a chamber with two inlets and one outlet.

The electronic mixing valve 507 is pulsed by the micro-controller 506. The micro controller 506 is adapted to receive processed signals from at least one CPU 101 which in turn is adapted to receive signals from at least one accelerometer, at least one oxygen sensor, at least one gas flow sensor, at least one mixing valve, at least one digital input source, and a wireless transceiver. Each of the gases enters the mixing chamber proportionally to the opening of the inlet. The precisely mixed gas/oxygen mixture then flow to the outlet ports 119, or 112.

One embodiment of the invention comprises three outlet ports as depicted in 108, 112 and one auxiliary with bleed 119. The bleed port 119 is used for low flows. On the diagram it is the port furthest to the right. The bleed 119 is required to correct the gas mixing at very low flows.

The electronic valve 507 as used herein comprises embodiments in a variety of valve types, such as the ones used in the automatic control of air, gases and other compressible fluids. These include valve types which have linear and rotary spindle movement. Linear types include globe valves, sliding membrane seal, slide valves and bellows. Rotary types include ball valves, butterfly valves, plug valves and their variants. All of them can be used in the same way, for the same function to achieve the result of opening and closing the gas/oxygen port to the patient 114.

The wireless transmitter 107 as used in this invention comprises wireless communications which can be via: radio frequency communication, microwave communication, short-range communication, infrared (IR) short-range communication with at least one of the purposes being point-to-point communication, point-to-multipoint communication, broadcasting, cellular networks and other wireless networks. The wireless transmitter 107 for this air-blender 100 is embodied in a wireless local area network (WLAN) which links two or more air-blenders 100 over a short distance using a wireless distribution method, usually providing a connection through an access point for Internet access. The use of spread-spectrum or OFDM technologies allows the air-blenders 100 to move around within a local coverage perimeter, and still remain connected to the network. Products using the IEEE 802.11 WLAN standards are marketed under the Wi-Fi brand name. In another embodiment, the wireless transmitter 107 is a fixed wireless technology that implements point-to-point links between suction regulators 107 or networks at two distant locations, often using dedicated microwave or BLUETOOTH® signals.

In one embodiment of this invention, the power source 123, is at least one lithium-ion battery. Although a DC or AC cable attached to the device 100, would work in the same way to achieve the same function and give the same result as a battery powered air-blender 100. In this embodiment, a (lithium-manganese dioxide) LiMnO2 was used. This type of battery was chosen because the air-blender 100 requires long shelf life and the selected battery has a very low rate of self discharge, usually around 10 years. A lithium-ion battery (sometimes Li-ion battery or LIB) is a family of rechargeable battery types in which lithium ions move from the negative electrode to the positive electrode during discharge, and back when charging. Any other type of chemistry in the power source 123 can be used in the same way to accomplish the same result, which is to move a electronic valve 507 typically around 5 milliwatts per actuation.

In low pressure operation, this invention comprises an integrated alarm 120 system. In the event one of the inlet pressures is 20 PSI or more less than the other, the shuttle 501 will move away from the higher pressure gas towards the lower pressure. This will open up the flow of the higher pressure gas to the alarm reed and to the bypass 509. The pressure acting on the bypass check balls 508 will move the ball and spring back to allow the higher pressure gas to flow directly to the outlet ports 114, 112. Thus, the patient will never be without gas should one source fail. The alarm 120 will continue to sound and the bypass will remain open until the gases are back within 6 PSI of each other.

In an alternative embodiment of this invention a moisture mechanism is attached to the system 100. It is essential that the inspired air be moisturized. This is necessary to prevent drying of the respiratory mucosa and thickening of secretions that can further inhibit the flow of air through the air passages. Humidity may be provided by humidifying the oxygen in 116A with water, by aerosolizing the water into fine particles, or mist and adding it to the oxygen as it flows by into the mixing valve. A moisture sensor attached to the inlet of the oxygen will send the CPU 101 a signal that will in turn will adapt the electronic mixing valve 506 for the appropriate reading or preset. The CPU 101 will adapt to most patients need of 60% to 65% relative humidity at room temperature.

In at least one embodiment of this invention 100, the gas mixing apparatus comprises at least one electronic mixing valve 506, wherein said mixing valve responds to at least one CPU 101, the CPU 101 adapted to receive signals from at least one accelerometer 106, at least one oxygen sensor 109, at least one gas flow sensor 110, at least one mixing valve 113, at least one digital input source 102, and a wireless transceiver 107. The CPU 101 controls said at least one electronic mixing valve 506 by comparing stored preset values and adjusting said at least one electronic mixing valve through at least one feedback loop.

The invention herein 100 further comprises a method of precisely mixing gas 115A and oxygen 116A comprising the steps of: Using at least one electronic mixing valve 507; said electronic mixing valve 507 adapted to receive processed signals from at least one CPU 101; Wherein said at least one CPU 101 creates a feedback loop by receiving signals from at least one accelerometer 106, at least one oxygen sensor 109, at least one gas flow sensor 110, at least one mixing valve 113, at least one digital input source 125, and a wireless transceiver 107.

The gas mixing apparatus 100, further comprising at least one DC battery 123 or wall AC input converter or any combination thereof. The gas mixing apparatus 100, further comprising at least one pressure balancing assembly 111 and at least one alarm 120. The gas mixing apparatus 100, wherein the said at least one digital input source 125 comprises; a keyboard, an optical scanner, a camera, and a mouse, or any combination thereof. The gas mixing apparatus 100, further comprising at least one LCD display 103, a plurality of LEDs 124 and any combination thereof.

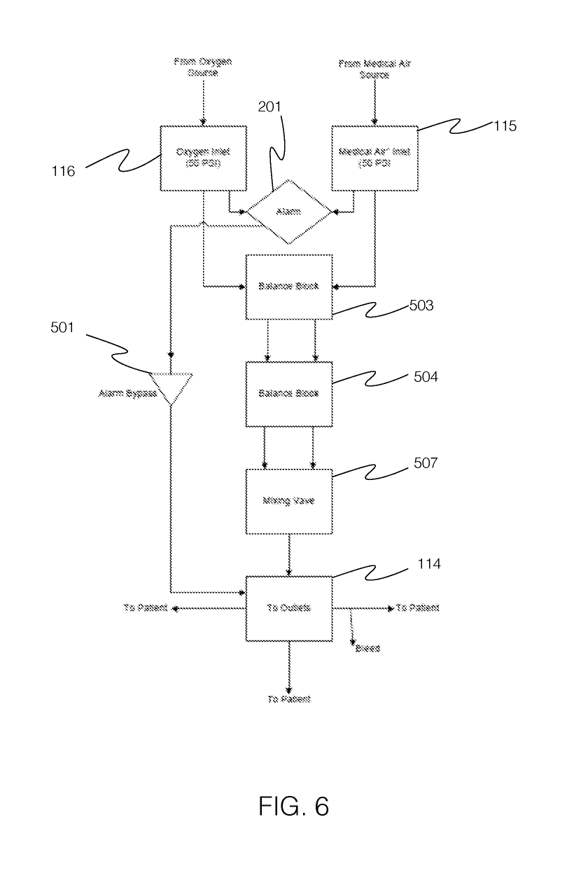

FIG. 6 depicts at least one embodiment of this invention in block-form. Here, the oxygen source inlet 116 is 50 PSI and medical air 115 also at 50 PSI, enter from medical air source they enter the first pressure balancing area 503. When the gases leave the first balancing module 503, they enter the second 504. Here, the gases are continuously much closer in pressure, due to the action of the first balancing module 503. The actions of the first module are repeated here to further equalize the pressures of the gases as they enter the electronic mixing valve 507. Each of the gases enters the mixing chamber proportionally to the opening of the inlet. The precisely mixed gas/oxygen mixture then flow to the outlet ports 114, 119, or 112. The Alarm/Bypass 120 Activation will begin when the inlet gas pressures differ by 20 PSI±2 or more, and the alarm Sound Generator Vibrating reed 201 will sound.

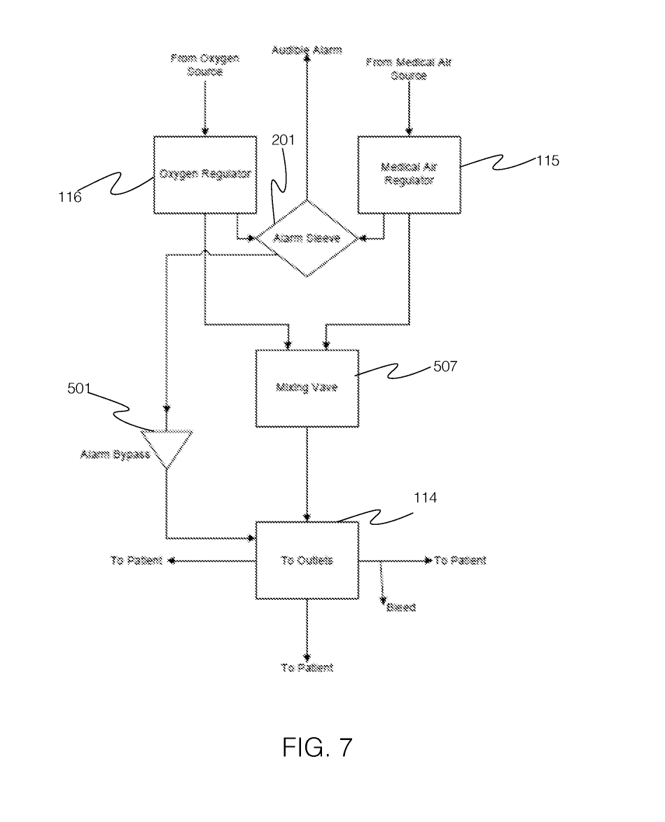

In an alternative embodiment of this invention, FIG. 7, in block form, no balancing areas are needed. Both oxygen 116 and medical air 115 come in to a pneumatic oxygen regulator 701, and a pneumatic medical air regulator 702 respectively. The equalized pressures of the gases enter the electronic mixing valve 507. Each of the gases enters the mixing chamber proportionally to the opening of the inlet. The precisely mixed gas/oxygen mixture then flow to the outlet ports 114, 119, or 112. The Alarm/Bypass 120 Activation will begin when the inlet gas pressures differ by 20 PSI±2 or more, and the alarm sound generator vibrating reed 201 will sound. Other non limiting example comprise, a hybrid regulator is created from a regulator and a solenoid valve with the electro-pneumatic regulator.

The precisely mixed gas/oxygen mixture then flow to the outlet ports 114, 119, or 112. The Alarm/Bypass 120 Activation will begin when the inlet gas pressures differ by 20 PSI±2 or more, and the alarm Sound Generator Vibrating reed 201 will sound.

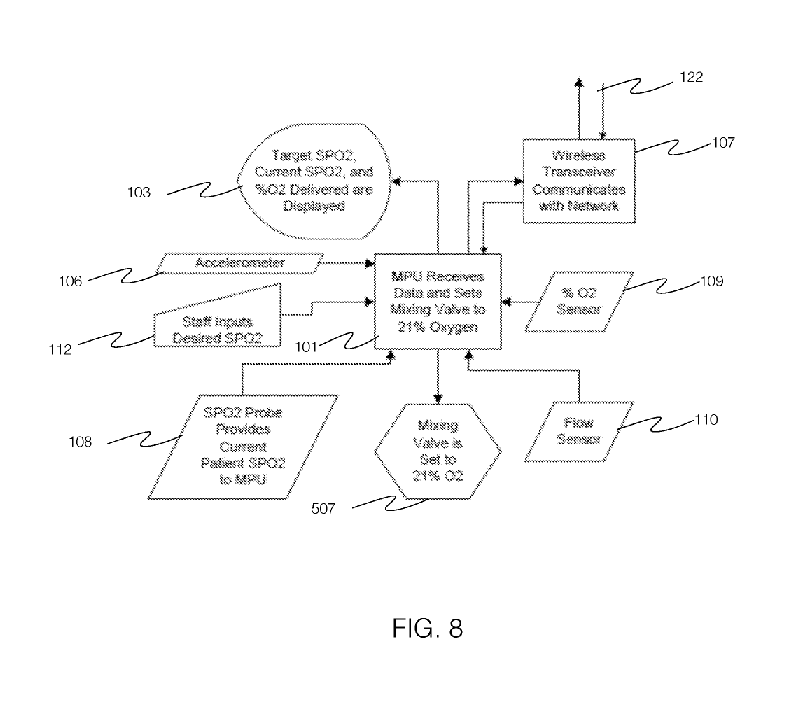

FIG. 8 depicts a non-limiting example of the initial set up for oxygen therapy. Here, CPU 101 receives the following inputs: 1. Oxygen sensor data 109, 2. Flow sensor data 110, patient SPO2 data 108, 3. staff input data 113, 4. Transceiver 107 communication data, and 5. accelerometer data 106. The CPU 101 then analyses the data and compare is to settings the ROM and does the following: 1. Displays 103 the target SP02, current SP01, %02 delivered, it also sends signals back to the wireless transceiver 107, and sends a signal to electronic mixing valve 507 to be set here at 21%.

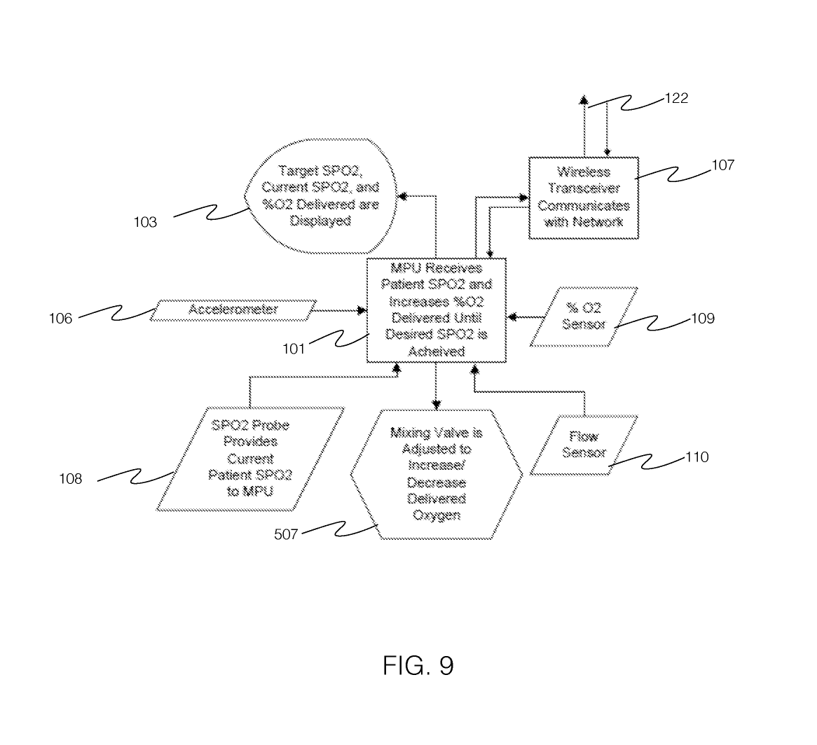

FIG. 9 depicts a non-limiting example of how to maintain and increase desired oxygen/gas mixture. Here, the CPU 101 receives the following inputs: 1. oxygen sensor data 109, 2. flow sensor data 110, patient SPO2 data 108, 3. Transceiver 107 communication data, and 4. accelerometer data 106. The CPU 101 then receives patient SP02 and modifies the % oxygen delivered to maintain the desired SP02, in the alternative, it receives the patient SP02 and increases % O2 delivered until desired SP02 is achieved using a feedback loop. The CPU 101 further does the following: 1. Displays 103 the target SP02, current SP01, % 02 delivered, it also sends signals back to the wireless transceiver 107, and sends a signal to electronic mixing valve 507 to be adjusted to increase or decrease the Oxygen delivered.

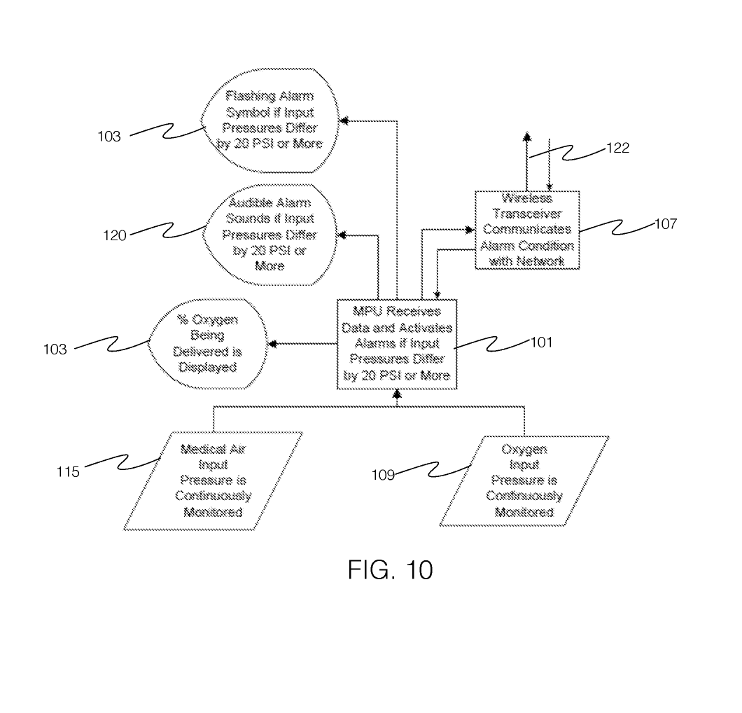

FIG. 10 depicts a non limiting example of how to the differential pressure alarm work. Here, the CPU 101 receives the following inputs: 1. Oxygen sensor data 109, 2. Medical air sensor data 115, Monitored patient SPO2 data 108, 3. Transceiver 107 communication data, and 4. accelerometer data 106. The CPU 101 compares data and if the Input pressures differ more than 20 PSI or more, then it does the following: 1. Displays 103 an alarm, and displays current SP02, % 02 delivered, it also sends an emergency signal back to the wireless transceiver 107, and sends a signal to audible alarm 201 to sound.

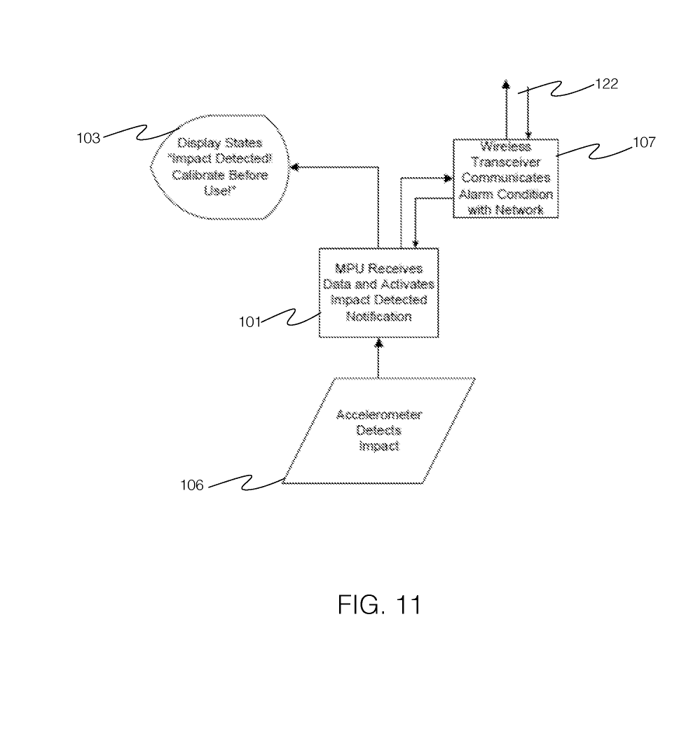

FIG. 11 depicts a non limiting example of how the impact alarm works. Here, the CPU 101 receives the accelerometer data 106 if there is an altered state. The CPU 101 compares data and if there is an alteration to the preset data, the CPU 101 does the following: 1. Displays 103 an alarm “impact detected”, 2. sends an emergency signal back to the wireless transceiver 107, and in the alternative sends a signal to audible alarm 201 to sound.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

We claim:

1. A gas mixing apparatus comprising:
a. At least one oxygen input-source, said at least one oxygen input-source further comprising at least one oxygen sensor;
b. At least one gas input-source, said at least one gas input further comprising a first gas flow sensor;
c. At least one combined gas output-source, said at least one combined gas output source further comprising a second gas flow sensor;
d. At least one electronic mixing-valve, said electronic mixing valve adapted to be controlled by at least one mixing valve or by at least one CPU;
e. A wireless transceiver, said wireless transceiver adapted to send and receive wireless signals to a network; and
f. At least one motherboard, said at least one motherboard further comprising, at least one CPU, at least one accelerometer, at least one i/o connector, said at least one i/o connector adapted to be demountably-attached to at least one digital input source, and at least one digital display;
g. Wherein, said at least one CPU controls said at least one electronic mixing-valve by the input of said at least one oxygen sensor, said first gas flow sensor, said second gas flow sensor, said at least one mixing valve, said wireless transceiver, and said digital input source or any combination thereof.

2. The gas mixing apparatus of claim 1, wherein the said at least one electronic mixing valve controls oxygen concentrations using at least one feedback loop.

3. The gas mixing apparatus of claim 1, wherein the increasing or decreasing amount of oxygen and gas delivered to the patient is automatically controlled according to the patient's need through at least one sensor.

4. The gas mixing apparatus of claim 1, wherein the increasing or decreasing amount of mixed gas and oxygen to the patient is automated.

5. The gas mixing apparatus of claim 1, further comprising at least one DC battery or wall AC input converter or any combination thereof.

6. The gas mixing apparatus of claim 1, further comprising at least one pressure balancing assembly and at least one alarm.

7. The gas mixing apparatus of claim 1, wherein the said digital input source comprises; a keyboard, a pulse oximeter, an optical scanner, a camera, and a mouse, or any combination thereof.

8. The gas mixing apparatus of claim 1, wherein the said at least one digital display is LCD display, a plurality of LEDs and any combination thereof.

9. A gas mixing apparatus comprising:
a. At least one electronic mixing valve, wherein said electronic mixing valve responds to at least one CPU, said at least one CPU adapted to receive signals from at least one accelerometer, at least one oxygen sensor, at least one gas flow sensor, at least one mixing valve, at least one digital input source, and a wireless transceiver; wherein said at least one CPU controls said at least one electronic mixing valve by comparing stored preset values and adjusting said at least one electronic mixing valve through at least one feedback loop.

10. The gas mixing apparatus of claim 9, wherein the increasing or decreasing amount of oxygen and gas delivered to the patient is automatically controlled according to the patient's need through at least one sensor.

11. The gas mixing apparatus of claim 9, wherein the increasing or decreasing amount of mixed gas and oxygen to the patient is automated.

12. The gas mixing apparatus of claim 9, further comprising at least one DC battery or wall AC input converter or any combination thereof.

13. The gas mixing apparatus of claim 9, further comprising at least one pressure balancing assembly and at least one alarm.

14. The gas mixing apparatus of claim 9, wherein the said at least one digital input source comprises; a keyboard, a pulse oximeter, an optical scanner, a camera, and a mouse, or any combination thereof.

15. The gas mixing apparatus of claim 9, further comprising at least one LCD display, a plurality of LEDs and any combination thereof.

16. The method of precisely mixing gas and oxygen comprising the steps of:
a. Using at least one electronic mixing valve; said electronic mixing valve adapted to receive processed signals from at least one CPU;
b. Wherein said at least one CPU creates a feedback loop by receiving signals from at least one accelerometer, at least one oxygen sensor, at least one gas flow sensor, at least one pulse oximeter, at least one mixing valve, at least one digital input source, and a wireless transceiver.

17. The gas mixing apparatus of claim 16, further comprising at least one DC battery or wall AC input converter or any combination thereof.

18. The gas mixing apparatus of claim 16, further comprising at least one pressure balancing assembly and at least one alarm.

19. The gas mixing apparatus of claim 16, wherein the said at least one digital input source comprises; a keyboard, an optical scanner, a camera, and a mouse, or any combination thereof.

20. The gas mixing apparatus of claim 16, further comprising at least one LCD display, a plurality of LEDs and any combination thereof.
